(19) United States
(12) Patent Application Publication
(10) Pub. No.: US 2012/0085869 A1
(43) Pub. Date: Apr. 12, 2012

(54) APPARATUS, METHOD AND SYSTEM FOR REMOVING ORBITAL DEBRIS

(76) Inventor: Peter Lloyd, Milton Keynes (GB)

(21) Appl. No.: 13/196,869

(22) Filed: Aug. 2, 2011

(30) Foreign Application Priority Data
Aug. 2, 2010 (GB) GB1012958.3

(51) Int. Cl. B64G 1/66; B64G 1/10

(52) U.S. Cl. 244/158.6

(57) ABSTRACT

Apparatus for a space platform comprises a magnetic field generator and/or an electric field generator respectively configured to generate fields for influencing the trajectory of one or more items of space debris passing within a region of the apparatus. A system comprising a plurality of such space platforms may be placed in an orbit proximal to an orbit containing space debris. An individual space platform or system thereof may be used in a method for displacing earth orbital space debris out of the orbit and either towards the Earth's atmosphere where it is likely to be destroyed by the burning on re-entry into the atmosphere, or into a safer orbit from which it may be collected or in which it may be left.

### RELATED APPLICATION

This application claims priority under 35 U.S.C. §119(a) to GB Patent Application No. 1012958.3, filed with the United Kingdom Intellectual Property Office on Aug. 2, 2010; the aforementioned priority application being incorporated by reference in its entirety.

### FIELD

The present invention relates to apparatus for a space platform comprising a magnetic field generator and/or an electrostatic field generator, a system comprising a plurality of the same and a method of operation thereof. In particular, but not exclusively, the present invention relates to displacing Earth orbital space debris.

### BACKGROUND

The human exploration of space has resulted in the launching of spacecraft and satellites into orbit around the Earth, as well as other space bodies such as the Moon and certain planets. Additionally, the human exploitation of space is no longer limited to exploration but also to its use such as by communication satellites and space platforms for performing non-gravity experiments, for example. As the exploitation of space continues, a variety of redundant objects, some of which may be large but many of which are relatively small and all which are typically referred to as “space debris”, can remain in orbit for extended periods of time. Thus a cloud of objects has built up in space, in particular in Earth orbits, i.e. in lower Earth orbit (LEO) and geosynchronous Earth orbit (GEO) as well as the orbital zone between the LEO and GEO orbits, and is continuing to grow. These orbiting objects are posing a growing collision hazard for functioning space vehicles and satellites. Furthermore, the presence of such space debris compromises the safety of astronauts, in particular during extravehicular activity (EVA) such as space walks.

The cloud of hazardous objects comprises objects which vary greatly in size from large intact booster rockets and satellites down to microscopic fragments of material released into orbit in events such as collisions and accidentally by astronauts during human EVA activities.

It has been calculated that at some point in the next few decades the space around the Earth will become too hazardous for safe human operation because of the risks of collision with the debris, c.f. Thomas E. Albert and William B. Margopoulos (IAA90-568) “if action is to minimise the generation of debris are not globally implemented, portions of the early own region may become unacceptably hazardous for some missions within a few decades”. Indeed a cascade effect is predicted because the collisions cause the release of more debris in a chain reaction like multiplication of fragments. It is likely that even a short time in the lower Earth orbital space, such as is experienced by communications and broadcast satellites on their way to geostationary orbit, will pose a serious risk of loss or damage of these valuable space assets.

Various approaches and methods for cleaning up this growing debris cloud have been proposed and studied in the past, examples of which may be found in the following non-limiting list of patent documents: U.S. Pat. No. 6,655,637 B1; U.S. Pat. No. 5,405,108; U.S. Pat. No. 5,082,211; U.S. Pat. No. 6,757,612 B1; U.S. Pat. No. 4,936,528; U.S. Pat. No. 4,991,799; U.S. Pat. No. 5,120,008; U.S. Pat. No. 5,153,407 and U.S. Pat. No. 5,421,540; the contents of all of which are included herein by reference.

Aspects and one or more embodiments of the present invention were devised with the foregoing in mind.

### SUMMARY

Viewed from a first aspect, the present invention provides apparatus for a space platform, said apparatus comprising a magnetic field generator configured to generate a magnetic field for influencing in space vacuum the trajectory of one or more items, such as fragments, of space debris passing within a region of the said apparatus.

Viewed from a second aspect, the present invention provides apparatus for a space platform, said apparatus comprising an electric field generator configured to generate an electrostatic field for influencing in space vacuum the trajectory of one or more items, such as fragments, of space debris passing within a region of the said apparatus.

The space platform may be dedicated to one or other of a magnetic field generator or electric field generator or support both a magnetic field generator and electric field generator. Optionally, the space platform may also comprise other functions such as that of a communications satellite or other space platform or vehicle.

Viewed from a third aspect, the present invention provides a method for displacing Earth orbital space debris, the method comprising: placing a magnetic field generator in an orbit proximal, including within, an orbit containing space debris; and generating a magnetic field sufficient to influence the trajectory of one or more items, such as fragments, of space debris passing within a region of said magnetic field generator.

Viewed from a fourth aspect, the present invention provides a method for displacing earth orbital space debris, the method comprising: placing an electric field generator in an orbit proximal, including within, an orbit containing space debris; and generating an electric field sufficient to influence the trajectory of one or more items, such as fragments, of space debris passing within a region of said electric field generator.

One or more embodiments may be implemented to remove one or other or both metallic and non-metallic fragments from an orbit around a space body, in particular from an Earth orbit. Such removal may be achieved by a remote non-mechanical approach which may reduce the risk of collision and damage to the space platform upon which the apparatus is located.

In particular, the influencing comprises deflecting said one or more items of space debris in space vacuum.

Suitably, the magnetic field generator and/or electric field generator is/are configured to generate said magnetic field and/or electric field to extend said region to beyond a space platform upon which said apparatus is supported. Thus, space debris a distance away from the space platform may have its trajectory influenced. Therefore, it may be possible to place the space platform in an orbit in which there is very little space debris yet influence space debris in an orbit in which there is a significant amount of space debris, thereby further minimising the risk of collision of space debris with the space platform and consequent damage to the space platform.

Typically, the magnetic field generator comprises an electromagnet and/or a permanent magnet. Superconducting magnets or magnets comprising super conducting material may be particularly suitable as high field strengths may be obtainable from relatively modest power input. A magnetic field strength substantially in the region of 1 to 10 Tesla is desired in the vicinity of the magnetic poles if the influence is to be effective further away, and preferably at the higher end of the range, or even higher strengths to influence the trajectories of space debris over a great a distance as possible. In theory, there need be no upper limit to the magnetic field strength although practical design considerations are likely to limit the feasible strength that may be obtained.

Typically, the electrostatic field generator comprises an arrangement including Van de Graaff generator principles and/or a static inverter circuit, and more particularly may comprise a Van de Graaff generator. The electric field generator may be a dipole or multipolar field generator includes an electric dipole having arms extendable or extending beyond the boundaries of the space platform on which it is supported.

In operation the method includes the magnetic field and/or electric field having sufficient strength to deflect said one or more items of space debris passing within said region of said magnetic field and/or electric field generator, for example influence the trajectory of said one or more items of space debris out of said orbit containing said space debris and in particular influencing or deflecting the trajectory of said one or more items of space debris such that said items of space debris are directed or fall toward re-entering the Earth's atmosphere. The magnetic and/or electric field may be configured to influence or deflect the trajectory, for example by manipulating the field geometry, shape or strength.

In one embodiment, one or more items of space debris may be captured by the magnetic field generator. For example, items of space debris which exhibit diamagnetic properties will be attracted and drawn towards a magnetic field generator such as a permanent magnet or electromagnet. Also, slow-moving ferrous items are likely to be attracted toward and captured by the magnetic field generator. Thus, the space platform may act as a “garbage collector” in respect of some items of space debris.

Suitably, a plurality of magnetic field generators and/or a plurality of electric field generators are placed in an orbit proximal to an orbit containing space debris thereby providing multiple points from which the trajectory of space debris may be influenced or deflected.

### BRIEF DESCRIPTION OF DRAWINGS

One or more embodiments in accordance with the present invention will now be described, by way of non-limiting example only, and with reference to the accompanying drawings in which:

FIG. 1 is a schematic illustration of a space platform in accordance with an embodiment of the invention;

FIG. 2 is a schematic illustration of the initial starting point and trajectory of a fragment of space debris;

FIG. 3 is a schematic illustration of the deflection of an uncharged ferrous fragment of space debris travelling at medium speed within the influence of a magnetic field generated on a space platform in accordance with an embodiment of the invention;

FIG. 4 is a schematic illustration of the deflection of an uncharged ferrous fragment of space debris travelling at low speed within the influence of a magnetic field generated on a space platform in accordance with an embodiment of the invention;

FIG. 5 is a schematic illustration of the deflection of an electrically charged ferrous fragment of space debris travelling at medium speed within the influence of a magnetic field generated on a space platform in accordance with an embodiment of the invention;

FIG. 6 is a schematic illustration of the deflection of an electrically charged ferrous fragment of space debris travelling at low speed within the influence of a magnetic field generated on a space platform in accordance with an embodiment of the invention;

FIG. 7 is a schematic illustration of the deflection of a metallic electrically charged non-ferrous fragment of space debris travelling at medium speed within the influence of a magnetic field generated on a space platform in accordance with an embodiment of the invention;

FIG. 8 is a schematic illustration of the deflection of a metallic electrically charged non-ferrous fragment of space debris travelling at low speed within the influence of a magnetic field generated on a space platform in accordance with an embodiment of the invention;

FIG. 9 is a schematic illustration of the deflection of a metallic uncharged non-ferrous fragment of space debris travelling at medium speed within the influence of an electric field generated on a space platform in accordance with an embodiment of the invention;

FIG. 10 is a schematic illustration of the deflection of a negatively charged fragment of space debris travelling at medium speed within the influence of an electric field generated on a space platform in accordance with an embodiment of the invention;

FIG. 11 is a schematic illustration of the deflection of a negatively charged fragment of space debris travelling at low speed within the influence of an electric field generated on a space platform in accordance with an embodiment of the invention;

FIG. 12 is a schematic illustration of the deflection of a positively charged fragment of space debris travelling at low speed within the influence of an electric field generated on a space platform in accordance with an embodiment of the invention; and

FIG. 13 is a schematic illustration of the effect of forces on the orbits of space debris fragments.

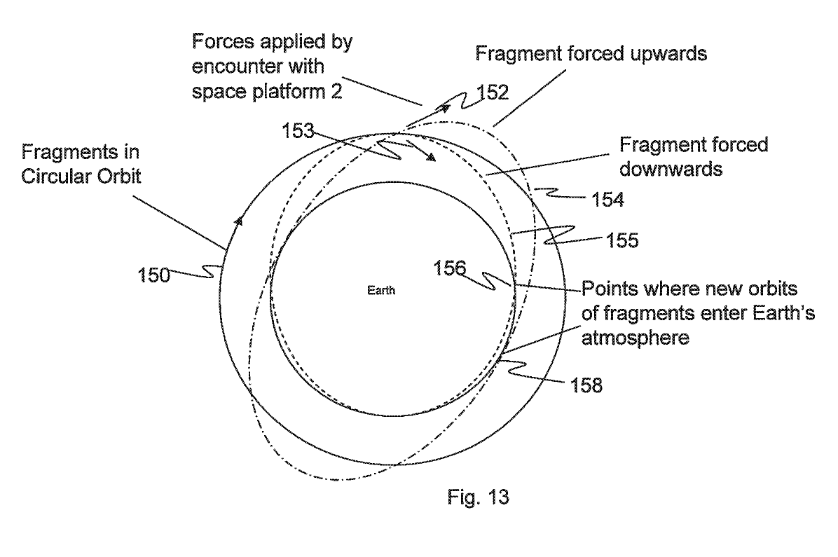

### DESCRIPTION

In general outline, one or more embodiments in accordance with the invention are intended to deflect, or at least influence, the trajectory of Earth orbiting debris into new orbits that result in the fragments of debris re-entering the Earth's atmosphere and thus no longer posing a threat to astronavigation and space assets. The deflection of the debris is accomplished by means of magnetic and electric fields generated deliberately by suitable magnetic, electromagnetic and electrical systems onboard orbital platforms. These orbital platforms may be dedicated to the mission of orbital debris removal or may have other missions and purposes besides orbital debris removal. When a fragment of orbital debris passes through the magnetic and or electrical fields generated by the invention they experience forces that cause them to be deflected in their orbital path.

In the case of debris that are conductors of electricity the magnetic field will cause eddy currents to be generated in the debris in the well understood process of a conductor experiencing a changing magnetic field. These eddy currents give rise to a magnetic field in opposition to the generated magnetic field and a deceleration force is felt by both the debris and the satellite carrying the invention. Also, the eddy currents dissipate heat into the debris which comes originally from the kinetic energy of the fragment.

In the case where an electrostatic field is generated by the invention then the effect on a metallic fragment of debris will be to cause the free electrons in its atomic structure to move towards the positive direction of the electrostatic field leaving a net positive charge on the part of the fragment furthest away from the side with the electrons cloud on. Thus the metallic fragment will have become electrically polarised. The fragment will then experience a net force if the field strength is greater on one of the charged sides than at the other. This force will cause the fragment to change its orbital parameters and possibly re-enter the Earth's atmosphere.

For non-metallic fragments of debris the magnetic field will produce a much lower force than experienced by a metallic fragment and in this case the effect will be via the well known paramagnetic effect and/or the diamagnetic effect. For a non-metallic fragment the electrostatic field will cause electric charge polarisation to occur on the fragment and a net force that may cause the fragments to re-enter the Earth's atmosphere.

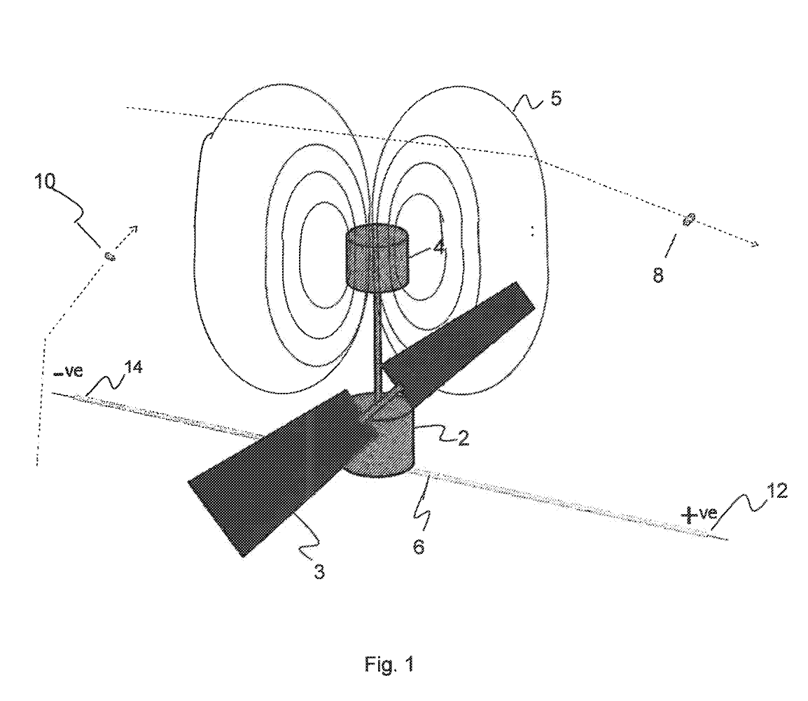

Referring now to FIG. 1 a space platform 2 is illustrated supporting a solar panel 3 from which electrical power for powering functions of the space platform 2 is obtained. Optionally, nuclear or chemical sources for the generation of the electricity needed for platform 2 may be used. Space platform 2 supports an electromagnet 4 and an electrostatic field generator 6. A representation of the field generated by electromagnet 4 is labelled 5. Also, examples of space debris are schematically illustrated with reference 8 representing an item of metallic space debris and reference 10 representing an item of non-metallic space debris.

The electrostatic field generator 6 illustrated in FIG. 1 is an electric dipole having positive, 12, and electrically negative, 14, parts.

Examples of magnetic field generators suitable for use in an embodiment of the invention are those used with medical scanners such MRI or CAT scanners. Additionally the magnetic field generators used in the Large Hadron Collider at CERN and those used for containment of the plasma in toroidal nuclear fusion reactors are of the kind suitable for an embodiment of the invention. Field strengths of several Tesla at the poles of the fields will be required, for example in the range of 1 to 10 Tesla although higher field strengths may be used.

Examples of electrostatic field generators suitable for use in an embodiment of the invention are those used in heavy atomic Ion particle accelerators and lightning research houses. Field strengths of tens of millions of volts per metre are desirable for this application.

In accordance with an embodiment of the invention, space platform 2 is placed into an Earth orbit in, adjacent to or proximal to an orbit containing space debris. In particular, space platform 2 is placed in an orbit in which the magnetic and electric fields generated on the space platform may influence the trajectory of space debris in low Earth orbit. Space platform 2 may be put into orbit by conventional rockets or by “space planes” such as the shuttle.

Once in orbit the space platform 2 will deploy the solar panels 3 to generate electrical energy for the electro-magnet 4 and to drive the source for the electrostatic field generator 6. The magnetic field generated by electromagnet 4 and electric field generated by electrostatic field generator 6 will inevitably interact with the Earth's magnetic field. As a consequence of this interaction the space platform 2 will have its attitude adjusted by the fields of electromagnet 5 such that the magnetic field 5 aligns with the Earth's magnetic field. Therefore, the orientation of the magnetic field and electric field on the space platform 2 relative to the trajectory of an item of space debris within the influence of those magnetic and electric fields will change. However, the change is likely to be relatively small for the period that the item of space debris is within the influence of the fields. Furthermore, although the items of space debris will be in substantially the same orbital shell, i.e. altitude above the earth, their trajectories will be in different directions. Thus, items of space debris will be coming into the influence of the fields from different directions albeit substantially within the plane of the same orbital shell or region.

In light of the fact that items of space debris will enter the influence of the magnetic and electric fields with different trajectories the effect of the space platform 2 changing attitude due to the influence of the Earth's magnetic field is unlikely to be deleterious in terms of the overall effect when aggregated across all the items of space debris likely to come within the influence of the magnetic and electric fields of the space platform 2. Therefore, no action with regard to the changing attitude need be taken.

However, if it desired to maintain a constant altitude, or at least control the altitude of the space platform rocket, engines could be included on the space platform.

Without being bound by any particular theory, examples of the behaviour of different types of orbital debris fragments in a magnetic field generated in accordance with one or more embodiments of the present invention described with reference to the schematic illustrations in figure is 2-8. The orientation of the initial trajectory of each item of orbital debris fragment illustrated in the figures is the same for ease of comparison. The figures are by way of illustration only, and as noted in the foregoing paragraphs orbital debris fragments will have trajectories at different orientations to the magnetic field depending upon the attitude of the space platform 2.

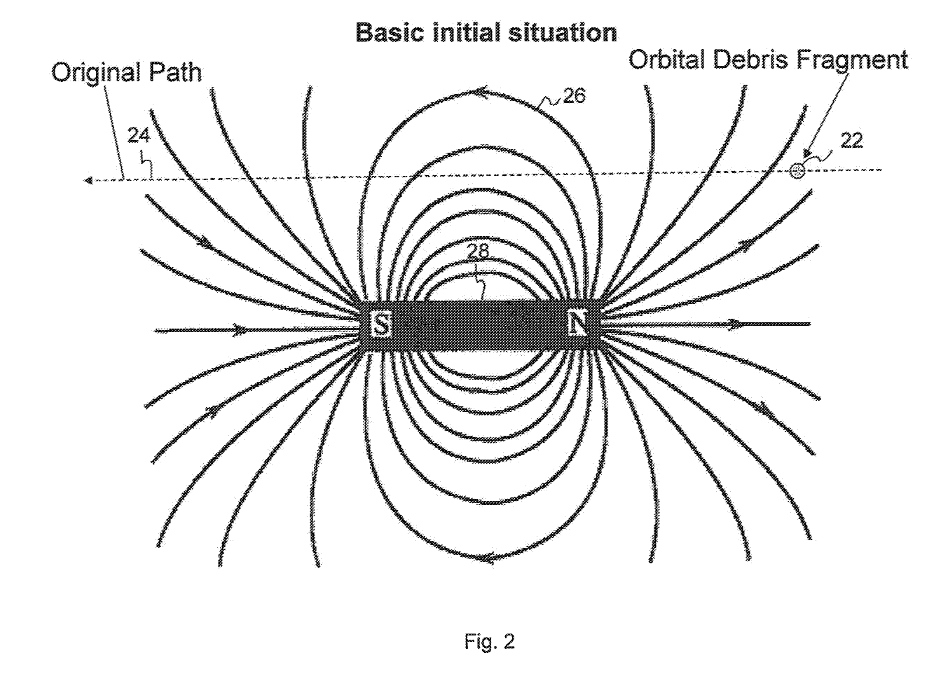

FIG. 2 schematically illustrates the initial situation for an orbital debris fragment 22 travelling in the direction of trajectory 24 as it comes into the influence of a magnetic field 26 generated by electromagnet 28. The material of which an orbital debris fragment consists may vary from fragment to fragment, and indeed it is likely that a fragment will consist of different types of materials. Some of these materials may be conductors whilst others may be dielectrics and even semiconductors and therefore their behaviour under the influence of magnetic field 26 will vary in dependence upon the materials from which they are made.

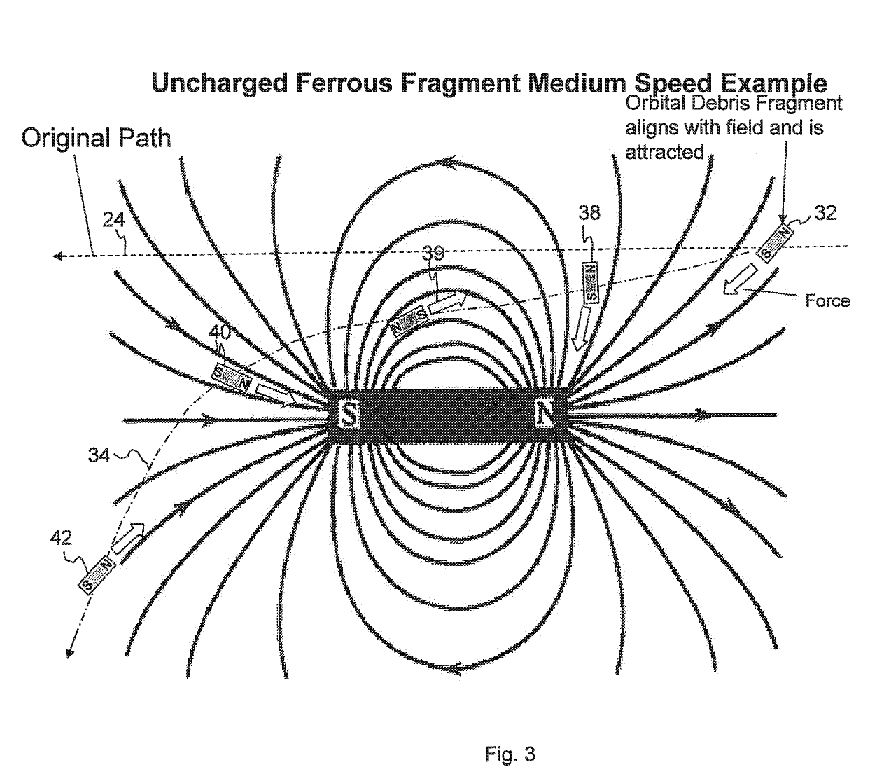

The behaviour of an uncharged ferrous fragment 32 travelling at a medium speed, e.g. in the range of 5 to 10 km per second, under the influence of magnetic field 26 is schematically illustrated in FIG. 3. Fragment 32 has an initial trajectory along the line 24, and under the influence of magnetic field 26 it acquires a magnetic dipole causing it to be aligned along the field lines of the magnetic field such that there is an attractive force between one magnetic pole of fragment 32 and the opposite magnetic pole of electromagnet. The combination of the initial trajectory and the attractive force causes fragment 32 to deviate from its initial path on 24 onto a deflected trajectory 34. As can be seen from FIG. 3 as fragment 32 travels along deflected path 34 its orientation and behaviour alters. For example, at position 38 the orientation of the fragment has tilted due to the attractive force between respectively polarised poles of the fragment and the electromagnet 28.

As fragment 32 passes through the field its orientation flips due to the influence of the other pole of electromagnet 28 dominating its behaviour as can be seen at position 39. Fragment 32 continues along deflected trajectory 34 under the influence of magnetic field 26 passing through position 40, where again it can be seen that the orientation of fragment 32 has changed, and finally through to position 42 as it exits the influence of magnetic field 26. Due to the initial speed of fragment 32 it is not captured by electromagnet 28 and continues in the final direction of trajectory 34 once it exits the influence of magnetic field 26.

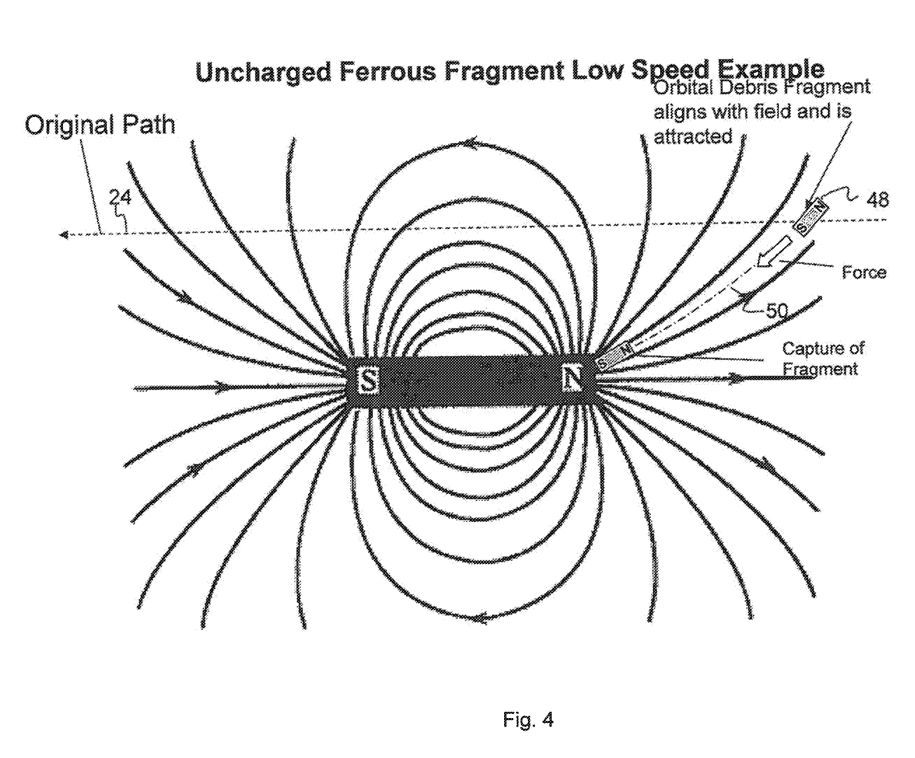

A schematic illustration of the situation for a ferrous fragment at a low speed is schematically illustrated in FIG. 4. In the illustrated example fragment 48 comes under the influence of magnetic field 26 while travelling along original trajectory 24. As before, a magnetic dipole is formed on fragment 48 creating an attractive force between fragment 48 and electromagnet 28. Since fragment 48 is travelling at a relatively low speed, e.g. in the range 0 to 5 km per second it travels along deflected trajectory 50 and is captured by electromagnet 28.

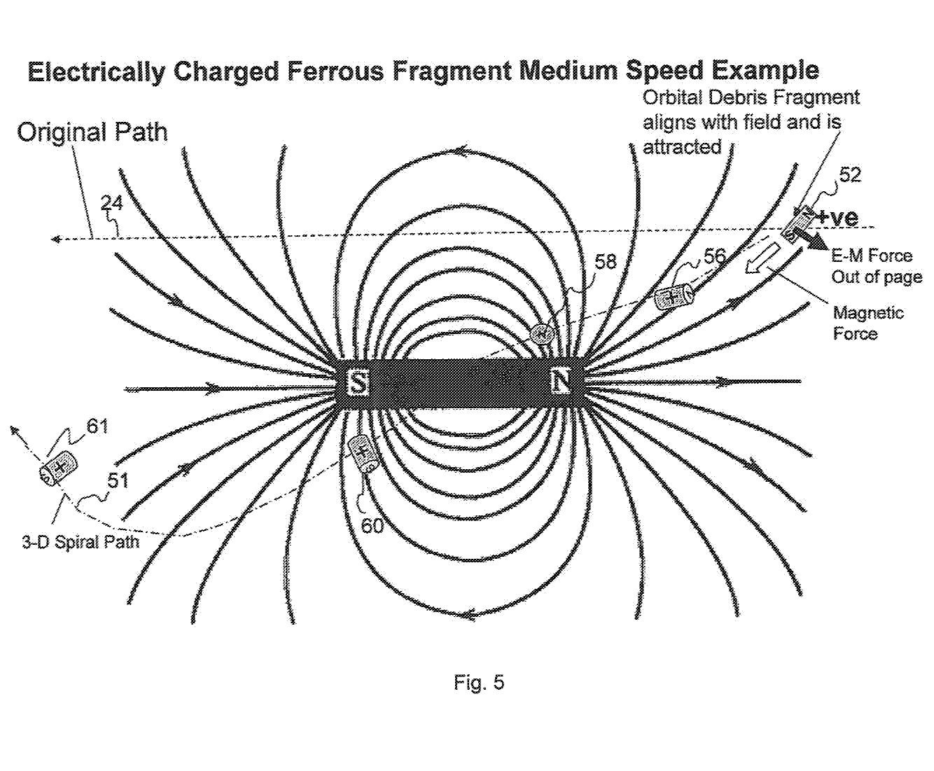

The situation for an electrically charged ferrous fragment travelling at a medium speed is illustrated in FIG. 5. Electrically charged ferrous fragment 52 enters the influence of magnetic field 26 along trajectory 24. As before, a magnetic dipole is formed on fragment 52 which creates an attractive magnetic force between it and the opposite pole of electromagnet 28. Since fragment 52 is charged its movement in magnetic field 26 results in an electromagnetic force perpendicular to its direction of motion and direction of the magnetic field in which it is travelling. In the example illustrated in FIG. 5 the electromagnetic force is in the direction extending out of the page on which the figure is illustrated.

The combination of the electromagnetic force and the attractive magnetic force causes fragment 52 to undergo a deflected trajectory 51 that is spiral. Fragment 52 travels along the spiral trajectory 51 through positions 56, 58, 60 and 61 providing snapshots of how the orientation of the fragment changes as it passes through the magnetic field, and then exits the influence of magnetic field 26.

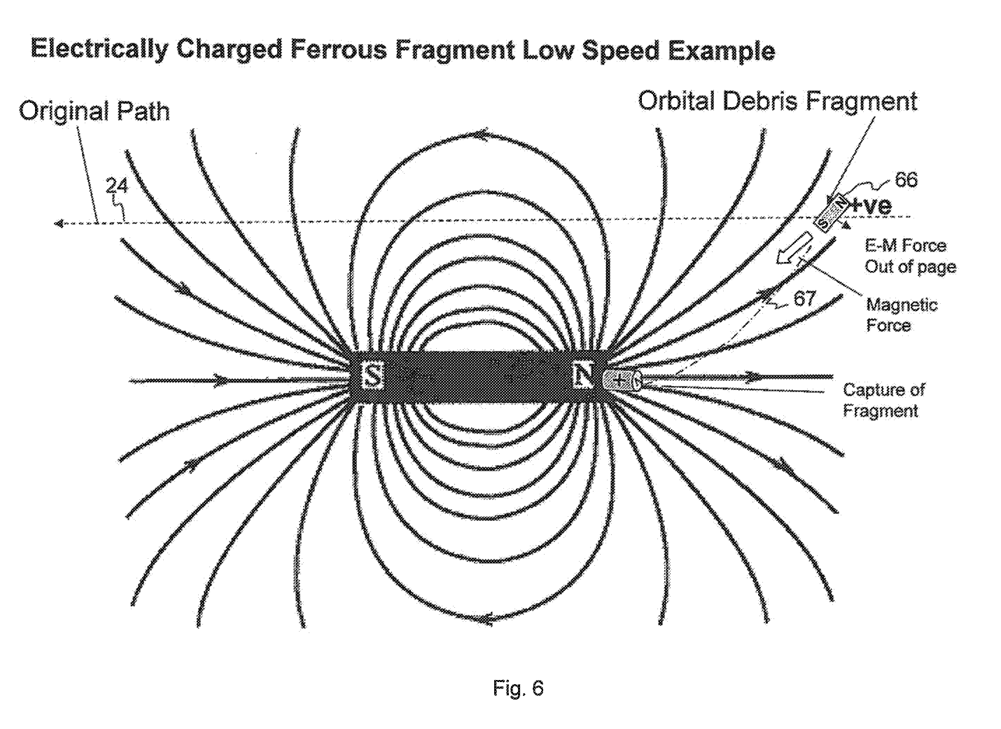

The change in trajectory of an electrically charged ferrous fragment 66 entering the influence of magnetic field 26 at a relatively low speed is schematically illustrated in FIG. 6. As with the situation illustrated in FIG. 5, an electromagnetic force is generated proportional to the velocity of fragment 66 in the magnetic field 26. Due to the low speed of the fragment 66 it travels along deflected trajectory 67 and is captured by the electromagnet 28.

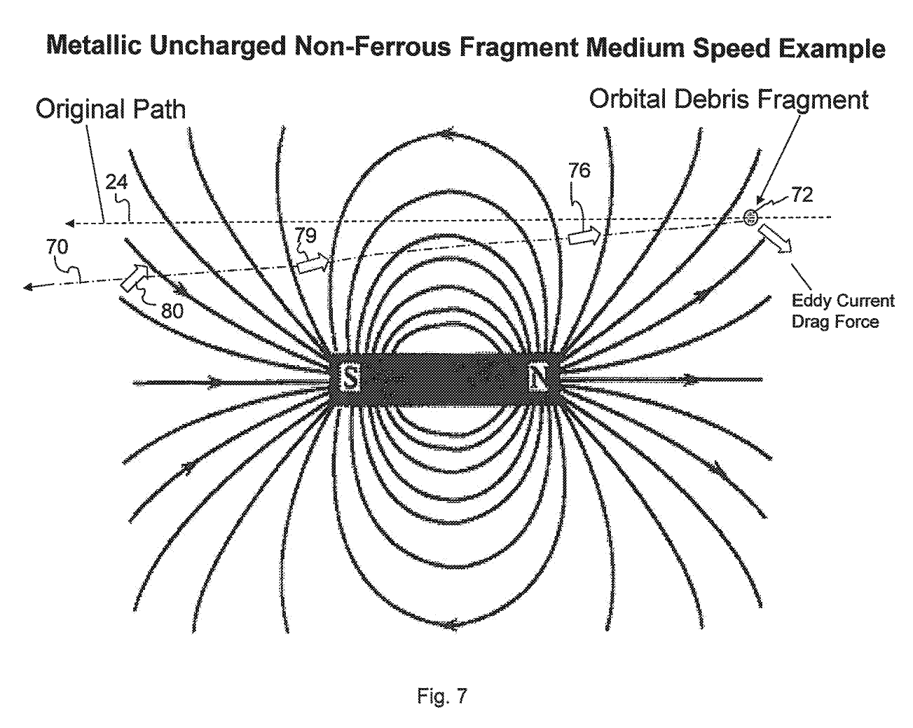

The deflection of a metallic uncharged non-ferrous fragment 72 travelling at medium speed along an initial trajectory 24 is schematically illustrated in FIG. 7. The motion of fragment 72 in magnetic field 26 results in eddy currents being generated in the metallic material of fragment 72. The eddy currents will generate a magnetic field which interacts with magnetic field 26 creating a drag force in a direction opposing the motion of fragment 72. As fragment 72 passes through magnetic field 26 along deflected trajectory 70 the direction of the eddy current changes due to the changing influence and direction of the magnetic field. For example, at the illustrated positions 76, 79 and 80 the eddy current force drag direction changes as fragment 72 passes through magnetic field 26.

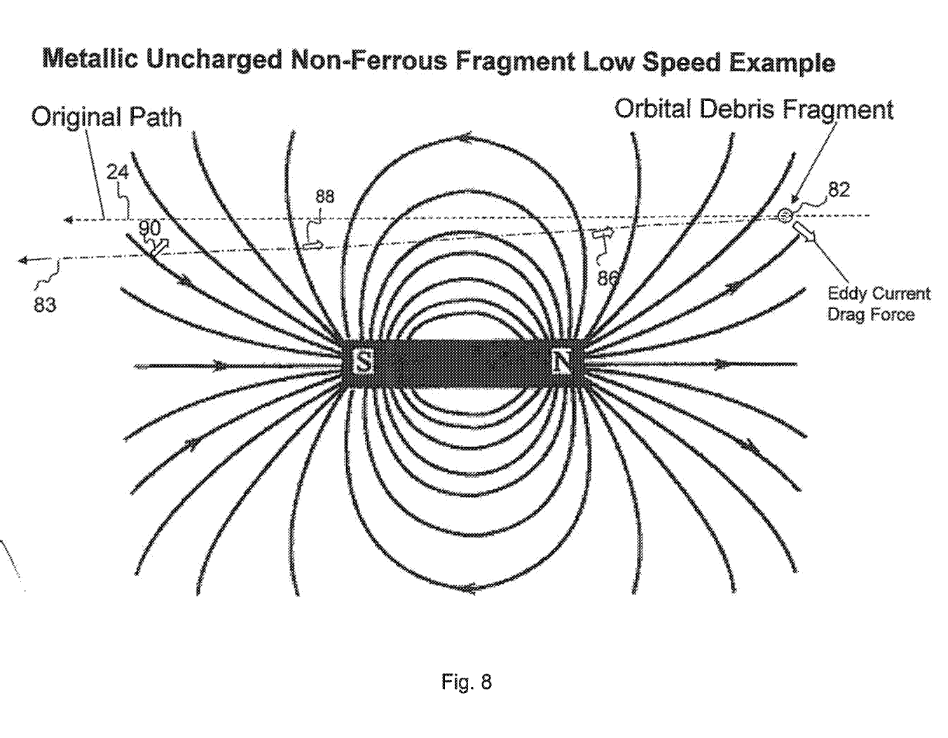

An example of the deflection of a metallic uncharged non-ferrous fragment travelling at low speed is schematically illustrated in FIG. 8. Fragment 82 experiences an eddy current drag force when it is travelling within the influence of magnetic field 26. As can be seen by following the deflected trajectory 83, the drag force changes direction, positions 86, 88 and 90, as it traverses the magnetic field. Since the fragment 82 is travelling at a low speed, the eddy currents produced in it are correspondingly low since they are proportional to the rate of change of magnetic flux and consequently fragment 82 undergoes less deflection than fragment 72 travelling at medium speed.

As can be seen from the foregoing description, the deflection of a space debris fragment is dependent upon the velocity of the fragment within the influence of the magnetic and/or electric field. The velocity of a fragment in a field is given by the equation:

v=2u cos(θ/2);

where v is the speed of the incoming fragment relative to the space platform 2; u is the circular orbital speed for the altitude of the fragment; θ is the angle of approach of the fragment from the forward part of the platform in its orbit and is assumed to be approximately in a horizontal plane relative to the vertical from the centre of the Earth.

The flux rate i.e. the number of fragments per square meter per second travelling towards an orbiting satellite from a given direction of the space debris fragments will be proportional to D.v, where D is the average density i.e. the number of fragments in a cubic metre of space at a given instant of time of the fragments in circular orbits within the influence of the magnetic or electric fields of space platform 2.

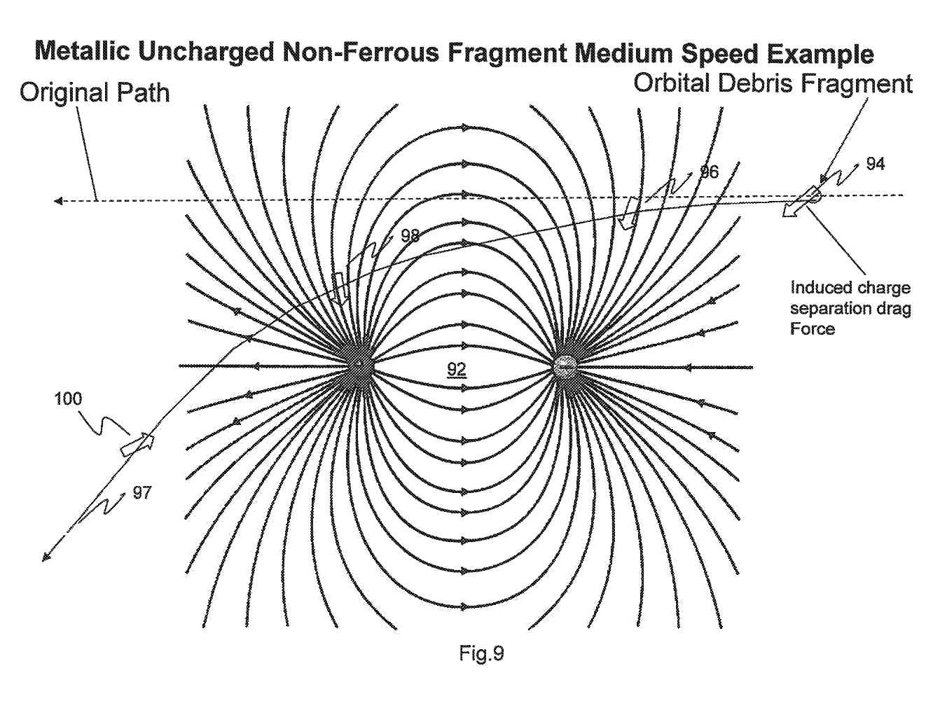

FIGS. 9 to 12 schematically illustrate the behaviour of examples of space debris under the influence of an electric field generated on the platform 2.

An example of the deflection of a metallic uncharged non-ferrous fragment travelling at medium speed in an electric field 93 generated by electric dipole 92 is schematically illustrated in FIG. 9. Fragment 94 has charge separation induced on it in the presence of the electric field 93 and a drag force is experienced on fragment 94 due to it travelling within the influence of electric field 93. Fragment 94 has an initial trajectory 95 and as can be seen by following the deflected trajectory 97, the drag force changes direction, positions 96, 98 and 100, as it traverses the electric field.

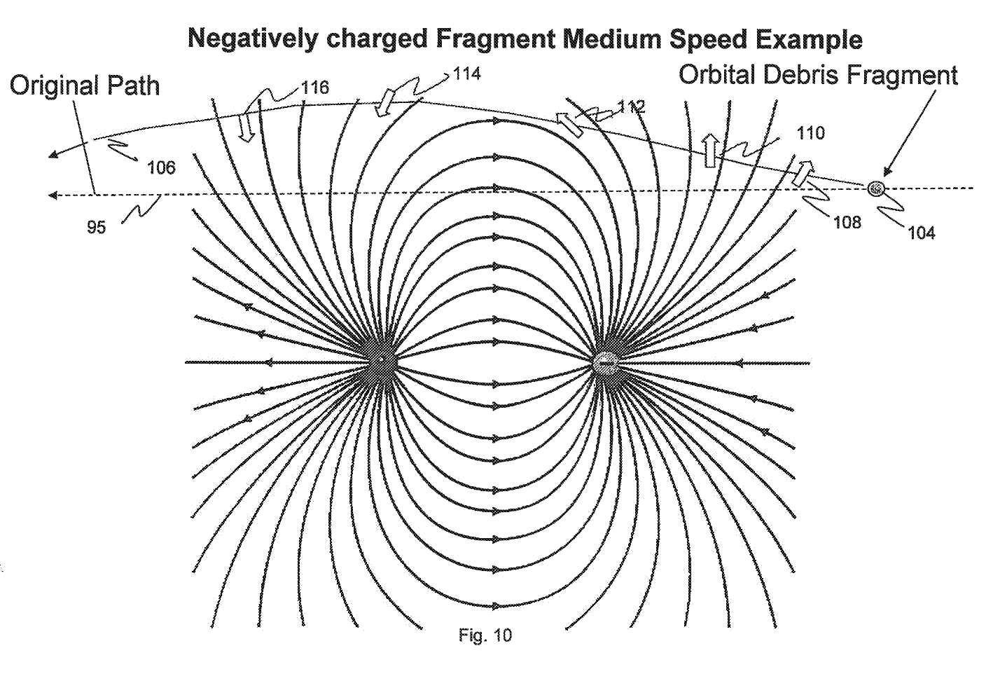

FIG. 10 schematically illustrates the behaviour of a negatively charged fragment 104 as it travels at medium speed within the influence of electric field 93. Fragment 104 enters the influence of the electric field along trajectory 95 and experiences a repulsive force in a direction away from the negatively charged pole as illustrated at reference 108. As fragment 104 continues on its deflected path 106 the repulsive force changes direction, positions 110 and 112, until the attractive force of the positively charged pole dominates the influence on fragment 104 as can be seen at positions 114 and 116 and turns the deflected path in a direction towards the positively charged pole.

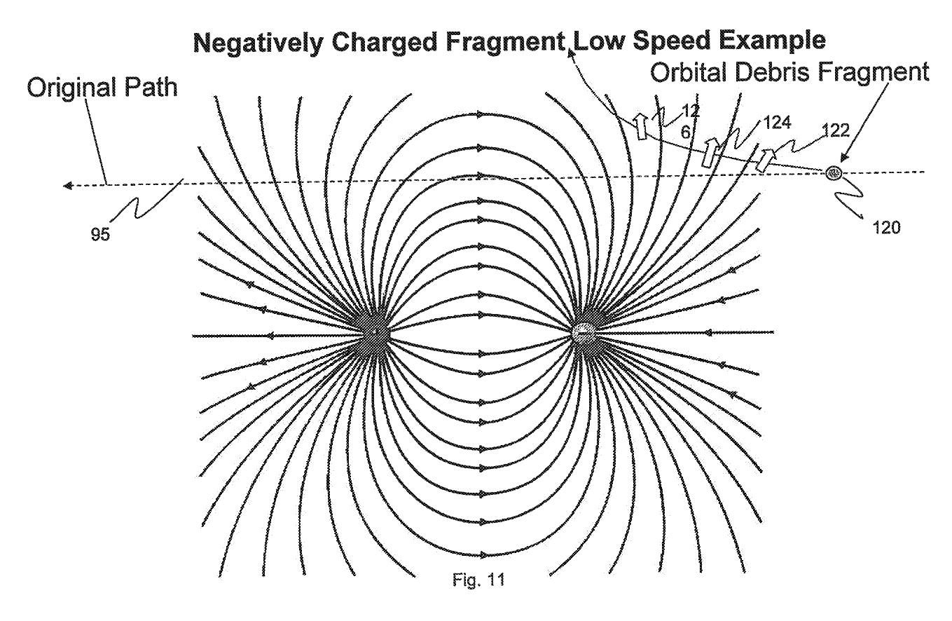

The behaviour of a negatively charged fragment 120 entering the electric field 93 along original path 95 at low speed is illustrated in FIG. 11. Since fragment 120 is travelling at low speed it does not have sufficient energy to transition into a part of the electric field in which the influence of the positive pole dominates and therefore the deflected trajectory follows a path through positions 122, 124 and 126.

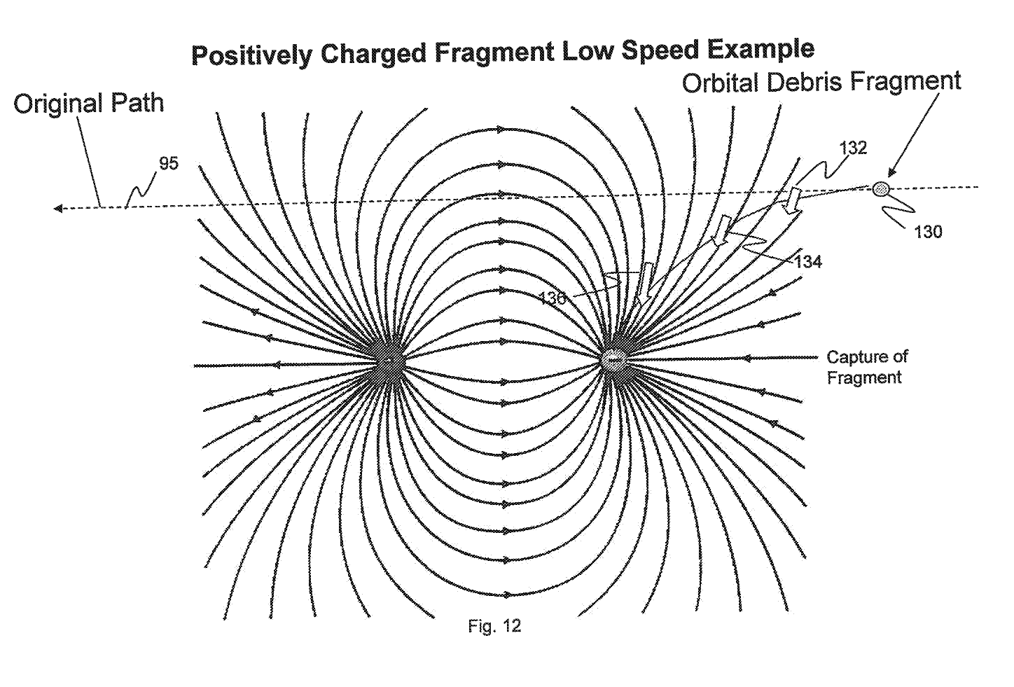

The behaviour of a positively charged fragment 130 entering the electric field 93 along original path 95 at low speed is illustrated in FIG. 12. Since fragment 130 is travelling at low speed it does not have sufficient energy to transition into a part of the electric field in which the influence of the positive pole dominates and therefore the deflected trajectory follows a path through positions 132, 134 and 136 to a position at which the fragment 130 is captured by the negative pole.

As will be apparent to the person of ordinary skill in the art the directions of deflection and effects will be reversed for fragments having opposite charges to those illustrated and entering the electric field 93 from the positively charged pole direction.

Further, the effects of the magnetic and electric field have been provided by way of non-limiting example and behaviours of fragment are not limited to those illustrated. Furthermore, the behaviours have been illustrated and described for a magnetic field and electric field in the absence of the other. It will be evident to the person of ordinary skill in the art that for an embodiment such as illustrated in FIG. 1 where both magnetic and electric fields may be present the behaviour of fragments will be more complex than illustrated and comprise vector addition of the forces experienced on them due to both the magnetic and electric fields.

In an optional embodiment, whilst both magnetic and electric field generators may be supported on space platform 2 they need not be operated simultaneously but operated in the absence of each other.

A summary of the various effects that the magnetic and electric fields have on space debris fragments is set out in the following table.

TABLE 1
De-Orbiting Debris Effects Table

| Debris | | |
|---|---|---|
| Type | Magnetic Dipole | Electric Dipole |
| Ferrous | [symbol] ARC | [symbol] AR |
| (uncharged) | | |
| Ferrous | [symbol] ARC | [symbol] ARC |
| (charged) | | |
| Metallic non- | [symbol] AR | [symbol] AR |
| ferrous | | |
| (uncharged) | | |
| Metallic non- | [symbol] AR | [symbol] ARC |
| ferrous | | |
| (charged) | | |
| Dielectric | No Effect | [symbol] ARC |
| (uncharged) | | |
| Dielectric | [symbol] AR | [symbol] ARC |
| (charged) | | |
| Mixed | [symbol] ARC | [symbol] AR |
| (uncharged) | | |
| Mixed | [symbol] ARC | [symbol] ARC |
| (charged) | | |

The notation in table 1 is used as follows;

an up arrow indicates that the fragment can be deflected in the vertical direction;
a sideways arrow indicates that a fragment can be deflected in the horizontal direction;
“A” indicates that a fragment may be accelerated relative to Earth centric coordinates;
“R” indicates that a fragment may be retarded relative to Earth centric coordinates; and
“C” indicates that a fragment may be captured by the space platform even if the original part of the fragment would have missed any physical structure on the space platform.

For ease of description and clarity the orbit of space debris fragments are schematically illustrated as a circular orbit 150, although as the skilled person will recognise orbits are generally not perfectly circular and often are elliptical. As described earlier with reference to FIGS. 2 to 12 space debris fragments may be deflected in different directions depending on the nature of the fragment material and fields. For a fragment forced in a generally “upwards” direction, 152, it enters an eccentric or elliptical orbit 154 which may bring it into the Earth's atmosphere at point 158. Likewise, for a fragment forced in a generally “downward” direction 153 and into an eccentric or elliptical orbit 155 and enters the Earth's atmosphere at point 156.

A fragment may not enter the Earth's atmosphere in its orbit immediately following its encounter with space platform 2 but several orbits later.

The overall effect and influence of the fields will be a statistical outcome, i.e. some fragments will be forced into orbits that enter the atmosphere, others will be relatively unchanged whilst some will be forced into an elliptical orbit that will be climb higher than the orbit that it was in but not descend into the atmosphere. The stronger the fields the more likely that more fragments will enter the atmosphere than would happen without embodiments of the invention.

As will be understood from the foregoing, one or more embodiments in accordance with the invention concern the generation of magnetic and electric fields that act on space debris fragments. The mechanisms for generating these fields are such that they are strong enough to have a de-orbiting effect over a large enough volume around the space platform supporting the magnetic and/or electric field generators such that a significant portion of the fragments of orbital debris are removed from Earth orbit during the lifetime of the apparatus and/or space platform. For the avoidance of doubt, the term space platform includes a satellite that carries apparatus the subject of this disclosure.

As used herein the term “space platform” is intended to encompass a wide variety of manned and unmanned space vehicles, including but not limited to vehicles for manned space travel, satellites, space stations, vehicles for deployment and recovery of satellites amongst other things. The term “space debris” as used herein is intended to encompass redundant or inactive satellites, sections of space vehicle launching equipment, small fragments and components jettisoned from spacecraft and launching equipment, all of which have maintained orbital velocity. The term “space debris, includes all objects large and small which had been placed in orbit by space related activities of any kind which are designed to be displaced from orbit.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

In view of the foregoing description it will be evident to a person skilled in the art that various modifications may be made within the scope of the invention. An arrangement, or plurality of arrangements, for generating magnetic and/or electric fields may be supported on a space platform as shown in FIG. 1 or any other suitable space platform such as a communications satellite. For example, the magnetic fields could be created by permanent magnets instead of or in addition to the electromagnet referred to in the detailed description. However, it is likely that the most practical method for creating the strongest field strengths as may be required is by means of electromagnetic circuits particularly those that use superconducting coils. Other conducting materials could be used but may produce weaker magnetic field strengths than the superconducting variety. Additionally, the vehicles for putting the space platform into orbit are not limited to conventional rockets or the space shuttle, but may include other suitable space vehicles for putting platforms into orbit.

The electrostatic fields could be generated by various mechanisms including Van de Graaff generator principle as well as by a static inverter circuit that takes direct current sources of electrical potential such as batteries and solar panels and converts it into alternating current that can be transformed into much higher electrical potential before once again being converted into D.C. which is suitable for creating an electrostatic field.

These field generators may be arranged on a single satellite platform as in FIG. 1 or may be arranged in arrays of field generators that are deployed once the satellite is in orbit as part of deployable booms or a plurality of space platforms.

### Numbered Clauses

The following numbered clauses are made reference to in order to further describe various embodiments included in the invention.

1. A space platform comprising:

an apparatus comprising at least one magnetic field generator configured to generate a magnetic field and at least one electric field generator configured to generate an electric field for influencing in space vacuum the trajectory of one or more items of space debris passing within a region of the said apparatus

2. A method for displacing earth orbital space debris, the method comprising:

placing a magnetic field generator in an orbit proximal an orbit containing space debris;

placing an electric field generator in an orbit proximal an orbit containing space debris;

generating a magnetic field sufficient to influence the trajectory of one or more items of space debris passing within a region of said magnetic field generator; and

generating an electric field sufficient to influence the trajectory of one or more items of space debris passing within a region of said electric field generator.

3. A method according to claim 2, further comprising generating said magnetic field to have sufficient strength to deflect said one or more items of space debris passing within said region of said magnetic field generator.
4. A method according to claim 2, further comprising configuring said magnetic field to influence the trajectory of said one or more items of space debris out of said orbit containing said space debris.
5. A method according to claim 2, further comprising configuring said magnetic field to influence the trajectory of said one or more items of space debris such that said items of space debris are directed toward re-entering the Earth's atmosphere.
6. A method according to claim 2, further comprising configuring said magnetic field to deflect the trajectory of said one or more items of space debris such that said items of space debris are directed toward re-entering the Earth's atmosphere.
7. A method according to claim 2, further comprising attracting items of said one or more items of space debris towards a generator of said magnetic field and capturing said items thereat.
8. A method according to claim 2, further comprising generating said electric field to have sufficient strength to deflect said one or more items of space debris passing within said region of said electric field generator.
9. A method according to claim 2, further comprising configuring said electric field to influence the trajectory of said one or more items of space debris out of said orbit containing said space debris.
10. A method according to claim 2, further comprising configuring said electric field to influence the trajectory of said one or more items of space debris such that said items of space debris are directed toward re-entering the Earth's atmosphere.
11. A method according to claim 2, further comprising configuring said electric field to deflect the trajectory of said one or more items of space debris such that said items of space debris are directed toward re-entering the Earth's atmosphere.
12. A method according to claim 11, wherein said electric field is a multipolar electric field.
13. A method according to claim 11, wherein said electric field is a dipole electric field
14. A method for displacing earth orbital space debris, the method comprising:

placing at least one electric field generator in an orbit proximal an orbit containing space debris; and

generating an electric field sufficient to influence the trajectory of one or more items of space debris passing within a region of said electric field generator.

15. A method for displacing earth orbital space debris, the method comprising:

placing at least one magnetic field generator in an orbit proximal an orbit containing space debris; and

generating an electric field sufficient to influence the trajectory of one or more items of space debris passing within a region of said electric field generator.

### CONCLUSION

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

What is claimed is:

1. An apparatus for a space platform, said apparatus comprising at least one magnetic field generator configured to generate a magnetic field and at least one electric field generator configured to generate an electric field for influencing in space vacuum the trajectory of one or more items of space debris passing within a region of the said apparatus.

2. An apparatus according to claim 1, wherein said influencing comprises deflecting said one or more items of space debris in space vacuum.

3. An apparatus according to claim 1, wherein said influencing comprises attracting items of said one or more items of space debris towards said magnetic field generator, and capturing said items at said magnetic field generator.

4. An apparatus according to claim 1, wherein said magnetic field generator is configured to generate said magnetic field to extend said region to beyond a space platform upon which said apparatus is supported.

5. An apparatus according to claim 1, wherein said magnetic field generator comprises an electromagnet.

6. An apparatus according to claim 1, wherein said magnetic field generator comprises a permanent magnet.

7. An apparatus according to claim 1, wherein said electric field is a dipolar electric field.

8. An apparatus according to claim 1, wherein said electric field is a multipolar electric field.

9. An apparatus according to claim 1, wherein said influencing comprises deflecting said one or more items of space debris in space vacuum.

10. An apparatus according to claim 1, wherein said electric field generator is configured to generate said electric field to extend beyond a space platform upon which said apparatus is supported.

11. An apparatus according to claim 1, wherein said electric field generator comprises an arrangement including Van de Graaff generator principles.

12. An apparatus according to claim 1, wherein said electric field generator comprises an arrangement including a static inverter circuit.

13. An apparatus according to claim 11, further comprising a Van de Graaff generator.

14. A system for displacing orbital space debris, the system comprising:
a plurality of space platforms that are positionable in an orbit that is proximal to an orbit containing space debris, each space platform being configured to:
place a magnetic field generator in an orbit proximal an orbit containing space debris;
place an electric field generator in an orbit proximal an orbit containing space debris;
generate a magnetic field sufficient to influence the trajectory of one or more items of space debris passing within a region of said magnetic field generator; and
generate an electric field sufficient to influence the trajectory of one or more items of space debris passing within a region of said electric field generator.

15. An apparatus for a space platform, said apparatus comprising at least one electric field generator configured to generate an electric field for influencing in space vacuum the trajectory of one or more items of space debris passing within a region of the said apparatus.

16. Apparatus for a space platform, said apparatus comprising at least one magnetic field generator configured to generate a magnetic field for influencing in space vacuum the trajectory of one or more items of space debris passing within a region of the said apparatus.
